(19) United States
(12) Patent Application Publication
(10) Pub. No.: US 2010/0023409 A1
(43) Pub. Date: Jan. 28, 2010

(54) METHODS AND SYSTEMS FOR ENHANCED ADVERTISING DISPLAY AND CONSUMER PURCHASE REQUESTS IN AN INTERACTIVE ENVIRONMENT

(76) Inventors: Antony A. Hilton, New York, NY (US); Gregory L. Hilton, New York, NY (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/507,529

(22) Filed: Jul. 22, 2009

Related U.S. Application Data
(60) Provisional application No. 61/082,627, filed on Jul. 22, 2008.

(51) Int. Cl. G06Q 30/00

(52) U.S. Cl. 705/14.72; 705/14.73

(57) ABSTRACT

Methods and systems for enhanced advertising display and consumer purchase requests in an interactive environment are disclosed. According to one embodiment, a computer-implemented method, comprises providing wrap code to a first entity connected to an electronic commerce network. A gadget is provided to the first entity. A request for content from a second entity connected to the electronic commerce network is received when the second entity activates the gadget. The content is transmitted to the second entity.

### PRIORITY

The present application claims the benefit of and priority to U.S. Provisional Patent Application No. 61/082,627 entitled “A METHOD AND SYSTEM FOR PROVIDING INTERACTIVE PROCESSING CONSUMER'S PURCHASE REQUEST IN AN INTERACTIVE ENVIRONMENT” and filed on Jul. 22, 2008, and is hereby, incorporated by reference.

### FIELD

The field of the invention relates generally to electronic commerce and electronic advertising systems, and in particular to methods and systems for enhancing and expanding online display and contextual word advertising, as well as for consumer purchase requests in an interactive environment.

### BACKGROUND

Currently, online advertising comprises a simple approach of “display” to internet users. Generally, tools, such as picture display “banners”, videos and applications called “widgets” display content comprising of limited information about products and services as a means of grabbing user attention and converting the user into a purchase for the product advertised. “Banners” are usually either static pictures or animated images that move, and can also provide some limited interactive capability other than a link redirection. Videos are quick presentations of advertisings which usually do not last longer than thirty seconds, though they can be shorter or longer depending on the desire of the originator of the video advertising. “Widgets” are applications that are small in memory which are interactive, providing some form of simple entertainment, and can change its content to feature different advertisements either connected with the interactive entertainment, or simply displayed with it.

Distribution of online advertisements can take place in one of three ways. One approach is the creation of an advertisement by an advertising entity or representative agent of an advertising entity which will provide the created advertisement directly to a website for display therein. This approach requires a website to integrate the advertisement into the HTML code of the website itself. An alternative approach to this is to establish a pre-assigned space on the website for advertisement display. This approach is used by the second and third alternative approaches mentioned above. In the second approach, an advertising entity or representative agent of an advertising entity will create the advertisement and then provide said advertisement automatically to a website through an automated server system. This system automatically distributes a created advertisement to the intended webpage. The webpage has incorporated into its HTML page a preassigned space for the ad display, and has integrated HTML code that calls or automatically receives from the advertising entity or representative agent of an advertising entity the ad as it is made available by the server system of the advertising entity or representative agent of an advertising entity. This integrated code can be authored to automatically change to different ads within the server of the advertising entity or representative agent of an advertising entity, and can also be displayed to a specific user based on predetermined demographic information.

The third alternative approach is the use by advertising entities or representative agents of an advertising entity of network services called “Ad Networks.” Ad Networks are entities that create a client list of website publishers who become a member of the Ad Network's network in exchange for a fee for each ad displayed on their webpage by the ad network. The Ad Network, in turn, obtains advertisers and their agents as client providers of online advertisements to use their network of web publishers to display ads to those internet users who visit the websites and web pages. An advertising entity or representative agent of an advertising entity pays for the privilege of accessing this network of sites and pages, where the fee is shared with the publishers. Advertisement distribution occurs the same as described above in the second alternative method.

Generally, this approach to online advertising has been proven to be extremely limited. Even with the provision of interactive content and capabilities, the bulk of online advertising is predominantly display ads and relies very heavily on grabbing the attention of the user and convincing them to use a link to navigate away from the page on which the ad was seen. This limitation is often overwhelming because internet users usually visit the websites on which they see advertisements with an intention that linking away through the advertisement would disrupt. As a result, many internet users ignore ads, and very few actually click through the link—and fewer still actually take the action to produce the ultimate result that is the goal of the advertiser and its representative agents: to make a purchase. To try to better entice users, advertisers have attempted to make their online advertisements more attractive and more active in one way or another, but this has simply prompted a response of users trying harder to ignore such ads.

### SUMMARY

Methods and systems for enhanced advertising display and consumer purchase requests in an interactive environment are disclosed. According to one embodiment, a computer-implemented method, comprises providing a gadget to a first entity connected to an electronic commerce network. Wrap code is provided to the first entity. A request for content from a second entity connected to the electronic commerce network is received when the second entity activates the gadget. The content is transmitted to the second entity.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF DRAWINGS

The accompanying drawings, which are included as part of the present specification, illustrate the presently preferred embodiment and together with the general description given above and the detailed description of the preferred embodiment given below serve to explain and teach the principles of the present methods and systems.

FIG. 1 illustrates an exemplary micro-site system, according to one embodiment.

FIG. 2 illustrates an exemplary system through which an advertising brand, manufacturer and/or service entity submits data for the generation of a wrap code and gadget, according to one embodiment.

FIG. 3a illustrates exemplary input data for the present system, according to one embodiment.

FIG. 3b illustrates exemplary output data that results from the processing system, according to one embodiment.

FIG. 4 illustrates an exemplary process for enhancing a creative online advertisement with the wrap code, and the distribution of an enhanced creative advertisement, according to one embodiment.

FIG. 5 illustrates an exemplary process in which a gadget is retrieved by a wrap code and populated by the gadget content database (GCD), according to one embodiment.

FIG. 6 illustrates an exemplary process through which a user interacts with, communicates, and retrieves data and content through a gadget, according to one embodiment.

FIG. 7 illustrates exemplary data that can be tracked and measured by the gadget and the gadget originator's processing system, according to one embodiment.

FIG. 8 illustrates an exemplary computer architecture for use with the present systems, according to one embodiment.

### DETAILED DESCRIPTION

Methods and systems for enhanced advertising display and consumer purchase requests in an interactive environment are disclosed. According to one embodiment, a computer-implemented method, comprises providing wrap code to a first entity connected to an electronic commerce network. A gadget is provided to the first entity. A request for content from a second entity connected to the electronic commerce network is received when the second entity activates the gadget. The content is transmitted to the second entity.

Each of the features and teachings disclosed herein can be utilized separately or in conjunction with other features and teachings to provide a method and system for visual-based interaction in a virtual environment. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense, and are instead taught merely to describe particularly representative examples of the present teachings.

In the following description, for the purposes of explanation, specific nomenclature is set forth to facilitate an understanding of the various inventive concepts disclosed herein. However, it will be apparent to one skilled in the art that these specific details are not required in order to practice the various inventive concepts disclosed herein.

The present invention also relates to systems for performing the operations herein. This system may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, and magnetic-optical disks, read-only memories, random access memories, EPROMs, EEPROMs, magnetic or optical cards, or any type of media suitable for storing electronic instructions, and each coupled to a computer system bus.

The methods presented herein are not inherently related to any particular computer or other system. Various general-purpose systems may be used with programs in accordance with the teachings herein, or it may prove convenient to construct more specialized system to perform the required method steps. The required structure for a variety of these systems will appear from the description below. In addition, the present invention is not described with reference to any particular programming language. It will be appreciated that a variety of programming languages may be used to implement the teachings of the invention as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also advertisement. The additional content, for example may be product details for the product being advertised, as well as interactive ordering information.

According to one embodiment, a widget delivers an advertisement to a user. While the widgets serves advertising content, gadget 104b contains content and is served by the advertisement (e.g. the advertiser publishes an advertisement that includes the gadget 104b after a web page loads on a browser). Gadget 104b is not implemented like prior art widgets. Prior widgets utilize substantial memory on a web page. Gadget 104b and wrap code 104a, in contrast, take up a small amount of memory. Gadget 104b remains invisible until called and hovers unanchored above the page content, requiring none of the space in the web page's layout when activated.

According to one embodiment, gadget 104b varies in size and can be a large file. According to this embodiment, wrap code 104a is very small without substantially changing the size of the advertisement. In this embodiment, the gadget 104b is not integrated with the advertisement, but instead only the wrap code 104a is integrated. According to this embodiment, the wrap code 104a fetches gadget 104b to provide additional content.

Gadget 104b is a standardized container application that can be changed and customized at any time and filled with any kind of content in a short amount of time. According to one embodiment, gadget 104b is custom made for each advertising widget. The advertiser using gadget 104b attaches wrap code to gadget 104b and then publishes an advertisement as normal. When the advertisement is published on a web page, the wrap code 104a fetches the gadget 104b to it where gadget 104b is essentially carried expressly noted that the dimensions and the shapes of the components shown in the figures are designed to help to understand how the present teachings are practiced, but not intended to limit the dimensions and the shapes shown in the examples.

The present system and methods overcome the limitations of prior systems by reversing the approach of current ads. Instead of trying to entice users to click links and navigate away from the websites and content to which they intently navigate, the present system serves the user, on the page at which they viewed the advertisement, all the content that would be available for review had they clicked/linked/navigated to through the online advertisement. This is done by taking existing ads and enhancing them with an application that displays additional content on demand. This is achieved with an application that produces code intended for integration with the online advertisement, and the code calls to it the display client which presents the information to the user.

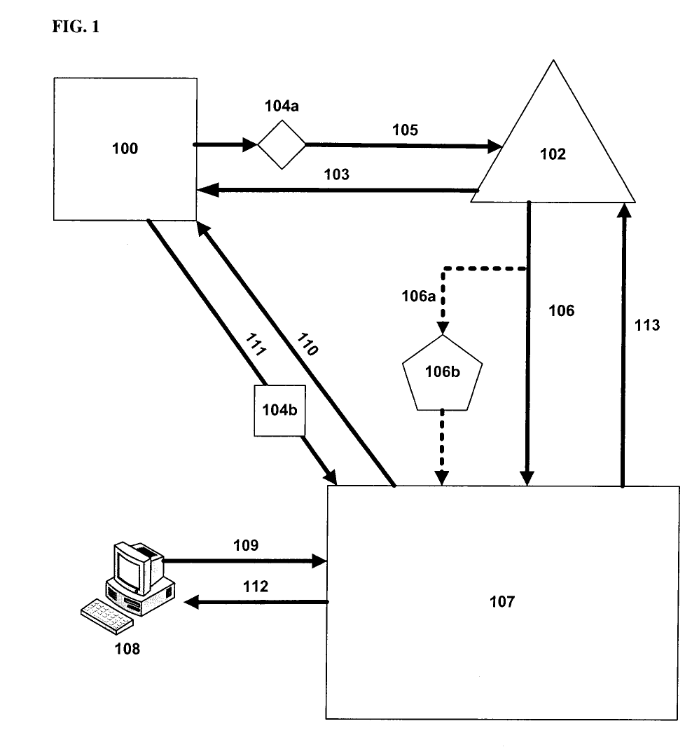

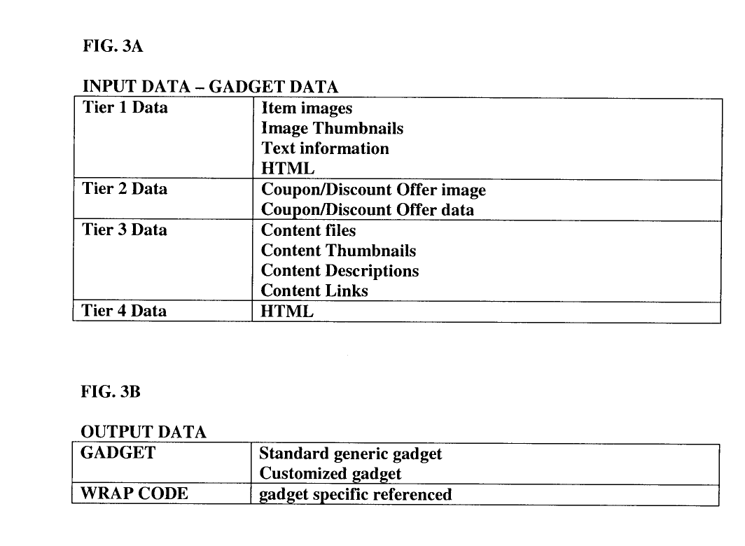

FIG. 1 illustrates an exemplary micro-site system, according to one embodiment. System 100 is a multi-functional micro-site service enhancement, distribution and transactional communication computer application and service. System 100 is distributed and facilitates communication between a user and an entity using the application and service. When an entity 102 takes action to make use of the application and service, they provide information (described below in FIG. 3a) to the application and service provider, 100. The data can be submitted to provider 100 via submission process 103 which can be either a manual submission to a data warehouse's staff, or transmitted via a transmission system.

Gadget 104b is computer-readable code that, according to one embodiment, allows additional content to be presented to a user when the user is served an with the advertisement to whatever web page it is published. Gadget 104b enhances advertisements and accordingly, any underlying widget.

Gadget 104b may be customized based on optional parameters provided to entity 102 via an automated online client system that is accessible by the entity 102 via a client account login, or by a data warehouse's staff based on written/verbal instructions provided by the entity 102. The administrative software reproduces the 104b gadget for each unique creative advertisement provided by the 102 entity, although the same produced 104b gadget can be used for more than one unique creative advertisement.

The submitted data is processed by system 100. Once processed, system 100 outputs two applications—a piece of wrap code 104a, and Application 104b, described here as a “gadget” (which shall be a representative word for the Application to be described herein without the assignment of any specific meaning other than as described herein). The wrap code 104a is distributed by system 100 for use by the entity 102 for integration into its creative advertising that is distributed to web sites. The gadget is stored within a gadget Server, either within the system 100 facility or within the facility of entity 102, and then distributed via the internet or other transmission system when the wrap code 104a is published onto a web page along with the distributed advertisement of entity 102.

Distribution of an advertisement with wrap code 104a by entity 102 occurs by any of the following processes, including, but not limited to: direct publishing to web page 107, which can occur as either a direct integration by the web publisher or as a distribution from an ad server located at entity 102 or associated with entity 102; or via intermediary 106b, such as an Advertising Network, to which entities 102 either links its ad servers or provides via 106a its creative advertising to the intermediary 106b manually or by transmission, which then is distributed by the intermediary 106b to a web page 107.

The creative advertising enhanced with the wrap code 104a is published on the web site/web page 107, and the web page 107 on which the enhanced creative advertising is loaded into an internet browser on a user computer 108 via a transmission system. The transmission system includes, but is not limited to, the internet or ISP connection. The wrap code 104a contacts a server located at system 100, to retrieve gadget 104b. Gadget 104b is the interactive application used by the user to retrieve information and communicate with and receive communication from advertising entity 102. The gadget 104b is transmitted back to the wrap code 104a on the 107 web page via a transmission system, such as, but not limited to the internet. The gadget 104b then resides on web page 107 and is invisible until the user 108 takes a specific action, such as using a computer interface device, such as, but not limited to, a mouse. The user action could be, but is not limited to, using a mouse to click an onscreen artifact, such as a graphic representation of a button, which is a visual manifestation of the wrap code 104a and the gadget 104b. Once this action is taken, the gadget 104b then becomes visible to the user 108 for review and interaction. It is important to note that the wrap code 104a can include the gadget 104b as a part of its function, no longer necessitating that a communication 110 occur.

Through the gadget 104b, the user can retrieve information, data and download content which can be served to the gadget 104b and the user 108 either directly from the entity 102 through the pathway 106, through a intermediary 106b via the pathway 106a, through the entity creating and distributing the wrap code 104a and gadget 104b through a pathway 103 which is collected and redistributed via a pathway 111 to the gadget 104b on the web page 107 loaded onto the user's computer 108 and internet browser, or service can be direct from the gadget/Wrap Code developer system 100 via the pathway 111. The user, in turn, can also directly communicate with the entity 102, uploading data and content or submitting other data, such as commerce transactions, either directly to the creative advertisement originating entity 102, or to an entity 102 that is a fulfillment center for such submission, or to an entity 102 via the system 100 through pathway 110 and 105, or to the system 100 for processing and fulfillment of such requests.

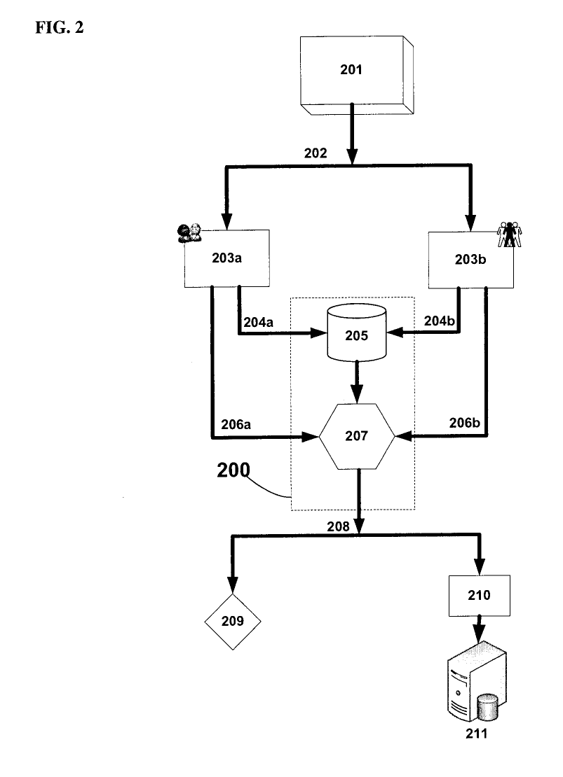

FIG. 2 illustrates an exemplary system through which an advertising brand, manufacturer and service entity 201 submits data for the generation of a wrap code 104 and gadget 104b, according to one embodiment. Through this system, entity 201 can submit to processing system and facility 200, data intended for population within gadget 104b. This submission can occur manually or via any available electronic system. The submission can be to an Automated Online Client system 203a, that resides either on a computer at the entity 201, or on the internet, accessible via a web page IP address by the 201 entity. In both instances, the entity 201 is provided an account accessible with a user name and password. The account can have multiple users with their own user name and password for use by multiple individuals.

Alternatively, a submission can be to data warehouse staff 203b. Any submission to the data warehouse staff 203b can be electronic or manual, and the data warehouse staff 203b will insert the data to the processing system and facility 200.

Submitted data is stored in a gadget content database (GCD) 205. This data populates a gadget 104b when it is created. Automated online client system 203a and/or the 203b data warehouse staff activates gadget administration system 207 to reproduce the gadget 104b for different data and tagging to different creative advertisements. The automated online client system 203a can be used by the entity 201 to customize the gadget 104b to include different services and interactive capabilities, or to take them away. Such customization can be set to be automatic based on time, number of units sold or downloaded, or based on any other limitation made available for use. The data warehouse staff 203b can also provide the same kind of customization based on instruction provided by the entity 201.

After the processing system 200 receives and stores the submitted data and implements the specified customized gadget 104b, it outputs two products, the wrap code 209 which the entity 201 uses to enhance its creative advertisements, and the gadget 210. The gadget 210 can have the submitted data inserted into it and stored as part of the gadget 210, or the gadget 210 can be automatically populated by the data when it is either loaded onto a web page 107 or when the gadget 210 is activated by and displayed to the user. The processing system 200 will automatically effect these gadget populations.

Once the data has been stored in the GCD 205, and the customized gadget 104b has been created, it is stored in the gadget storage server (GSS) 211. It is from here that the gadget 210 is served to the web page 107 when the wrap code, which identifies the specific gadget 210 associated with the creative advertisement, calls for the gadget 210 to it to the web page 107 on which the creative advertisement appears.

It is important to note that the submitted data provided by entity 201 to the GCD 205 can be assigned to multiple gadgets for multiple different creative advertisements.

FIG. 3a illustrates exemplary input data for the present system, according to one embodiment. FIG. 3b illustrates exemplary output data that results from the processing system, according to one embodiment. None of the input or the output represents all of the types of input and output that can result from the processing system 200. It merely represents some of the types of inputs requested for a gadget 210, and the types of outputs that can result. Each tier can represent the total and sole type of input that can be submitted by an advertising entity. For instance, the gadget 210 can simply contain HTML only.

Tier one of FIG. 3a can include item images, such as, but not limited to, images of the product being featured in the creative advertisement. For purposes of presentation of multiple images for review, image thumbnails can be used as selectors for additional images that represent the same product or peripheral products associated with the main product. Text information under tier one is used to describe in more detail the information about the featured product, as well as any other additional information the entity 201 may choose to reveal to an online user. HTML can also be used to enhance the text information, such as to change the text color or for changing the style of text for emphasis. Alternatively, text information could be replaced with HTML code entrirely, causing a different type of representation of information which could include text.

Tier two data inputs are usually data revolving around discounts for sale of products. In this tier, an entity 201 would submit an image of a graphical representation of a discount, often called a “coupon,” though it can include a multitude of graphical representations. Such representations can be included in gadget 104b for printing and physical use in brick and mortar stores and retail outlets. In addition to the image, tier two data also includes all information revolving around a discount offer, which includes expiration dates, the code of the discount for use in redeeming it, and the product for which the discount is intended. Tier two data is text, which is used for transmission via any electronic transmission system to email accounts and mobile devices so that it may be supplied to a retailer for use.

Tier three data has content files which are intended for download by a user. To graphically represent these files to users, thumbnails are used so that they may be displayed to the user to identify the content and for linking to download. Furthermore, text descriptions are used along with the thumbnail images so that the content may be further identified and described to the user. Lastly, content links are needed if the content is not stored and distributed from the servers of system 100. Links are any actionable element within the gadget 104b. For instance, a link-to-download can also be for the purpose of downloading from the system 100 as well as entity 201.

Tier four content is HTML code that is assembled by the entity 201 to produce a graphical display of information and interactivity within the gadget 104b. As HTML can be used in place of the text information as described above, HTML can also be used instead of all the above described features.

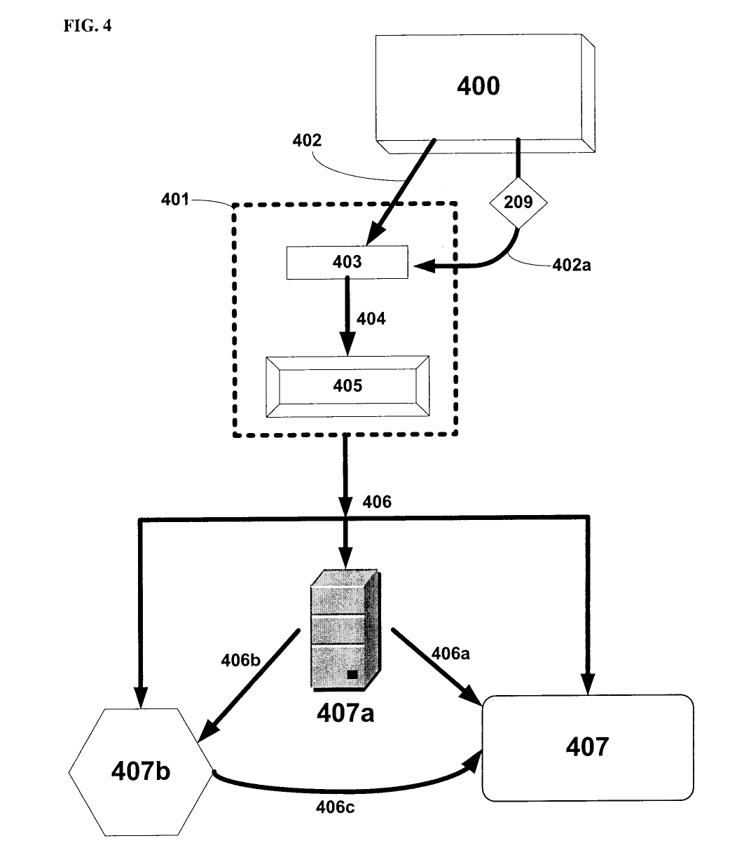

FIG. 4 illustrates an exemplary process for enhancing a creative online advertisement with the wrap code 209, and the distribution of an enhanced creative advertisement, according to one embodiment. Entity 400 produces a creative advertisement 403 intended for use and distribution onto the internet. Advertisement 403 is developed and converted into coding, usually HTML, that is usable on the internet and with an internet web page. As part of development process 401, there is an integration of the wrap code 209 to enhance the advertisement 403 into a gadget enhanced advertisement 405. Once developed into the enhanced advertisement 405 can be distributed to a web page 407 on the internet either directly, via an intermediary 407b, such as an Ad Network which then distributes the advertisement 405 to the web page 407 which is a member of its network, or via a web server 407a, operated either by the entity 400 or a separate independent representative agency that will either distribute to the web page 407 directly, or distribute to the web page 407 using intermediary 407b.

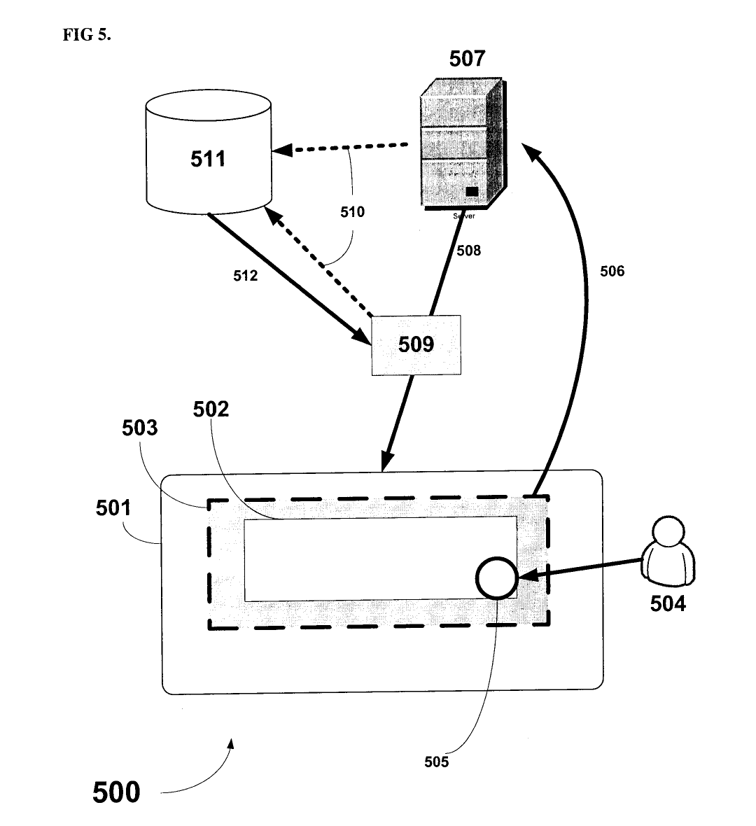

FIG. 5 illustrates an exemplary process in which gadget 210 is retrieved by a wrap code and populated by the gadget content database (GCD) 205, according to one embodiment. The computer displayed environment 500, in which a user's computer contains an internet web browser that navigates to and displays web pages 501, displays an enhanced advertisement 405 to the user 504. Enhanced advertisement 405 provides the user 504 a way to activate, display and access the gadget 509. Web page 501 displays to the user 504 an enhanced advertisement 405. Advertisement 405 has the original creative advertisement 502 converted into HTML code for use on the internet and which can take any form, such as, but not limited to, an image, a video, a flash construct or a word, and the wrap code 503 produced and outputted by the processing system 200 for use by the entity 400. The wrap code 503 is invisible to the user 504. Only the ad 502 is visible. However, the wrap code 503 does manifest an additional object for use by the user 504 as a way to activate, display and access the gadget 509. This can take the form, but is not limited to the form, of a button 505. Other forms in which the onscreen object 505 can be manifested includes links, images, etc.

In one embodiment, the wrap code 503 can automatically call to it and retrieve from the gadget storage server 507 the gadget 509, which can be transmitted via any available electronic system. Alternatively, in another embodiment, wrap code 503 may initiate a call to server 507 and retrieve gadget 509 when the user takes an action, such as, but not limited to, a mouse click, with object 505. Additionally, wrap code 503 could have the gadget 509 attached to it so that no call or retrieval is necessary from server 507.

In one embodiment, gadget 509 can have already integrated into it the submitted data contained in GCD 511. In another embodiment, gadget 509 could be empty of all data stored in the GCD 511 and populate itself with the data by a request 510 sent to the GCD 511 by either the GSS 507 or the gadget 509. In either instance, only the data of the GCD 511 assigned by the processing system 200 will populate the specific gadget 509, and the data can be requested for population either when the gadget 509 first loads onto the web page 501, or when the user 504 takes an action with the object 505. Additionally, if there are multiple displays within the gadget 509, population can occur all at once, or when the user 504 brings up a display.

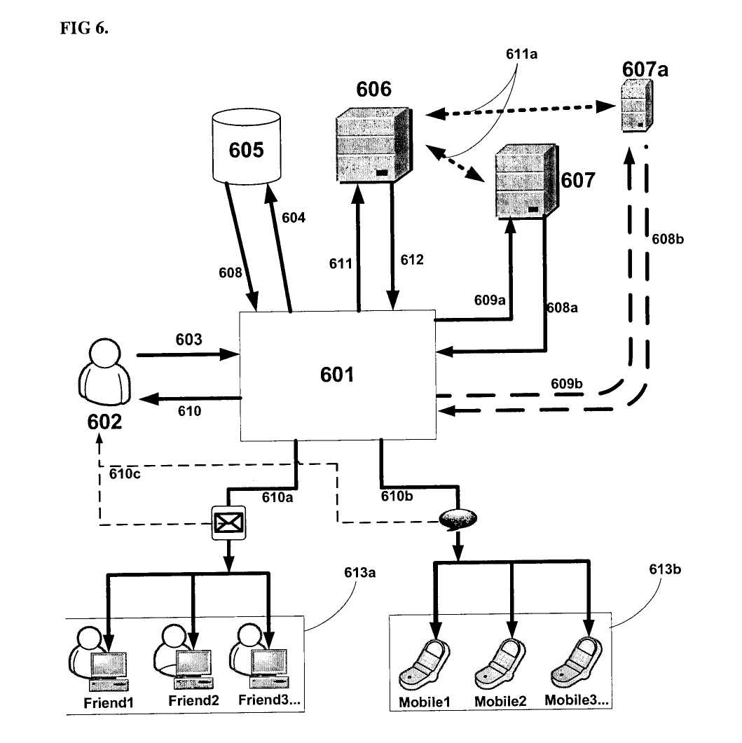

FIG. 6 illustrates an exemplary process through which the user 602 interacts with, communicates, and retrieves data and content through a gadget 601, according to one embodiment. The gadget 601 is an interface that provides the user 602 an interactive environment similar to a web page, with the availability of any feature that is and can be made available on the internet. When the user 602 interacts with it, the user 602 can navigate to multiple layers within the gadget 601 which are either a coded part of the gadget 601, or contained within HTML inserted into the gadget 601.

The gadget 601 retrieves content for population of the gadget 601 from the GCD 605, sending a request 604 through any available electronic transmission platform available, with the GCD 605 transmitting through the same or other available electronic platform the population data 608.

In instances where this embodiment of the gadget 601 provides the user 602 with the ability to communicate or transact with the entity 102 or the originator 100 of the gadget 601, which include, but are not limited to, transactions where the user 602 uploads content, downloads content or engages in commerce, the gadget 601 can communicate the user's 602 communication or transaction with the gadget originator's communication and transaction server 100, communicate or transact with the entity 102 communication and transaction server 607, or communicate or transact with the entity's 102 independent representative fulfillment communication and transaction server.

Alternatively, communications and transactions with either the entity's 102 communication and transaction server or with the entity's 102 representative fulfillment center communication and transaction server can occur via the gadget originator server 606 via the transmission 611a. Return communications and transaction confirmations 608 can be transmitted to the gadget 601 and communicated and displayed to the user 602 either from the entity's communication and transaction server 102 via the path 608a which uses any electronic platform available, from the entity's representative fulfillment center communication and transaction server 607a via the path 608b which uses any electronic platform available, and from the gadget originator's communication and transaction server 606 via the path 612 which uses any electronic platform available and receives such communications and transaction confirmations 608 via the return path 611a. Moreover, the gadget originator's communication and transaction server 606 can provide communication and transaction without interfacing with communication and transaction servers 607 and 607a.

The user 602 can also transmit sharable content through the gadget 601. Such transmission can take the form of, but not be limited to the form of, emails 610a and text messages 610b to mobile devices. An example of what can be transmitted in these formats includes, but is not limited to, coupons, including images of the coupon, the coupon code, the expiration date and any other pertinent data intended for sharing, including a link to a landing web page in which only the gadget, fully opened for use, is displayed. Such email transmission 610a can be directed and sent to user friends 613a that have computer-like systems that permit email; such text message transmission 610b can be directed to mobile devices 613b of user friends. Additionally, the emails 610a and/or the mobile text messages 610b can be directed at the 602 user him/herself. It is important to note, that the gadget can be implemented to transmit shareable content via any other form of communication or transmission available.

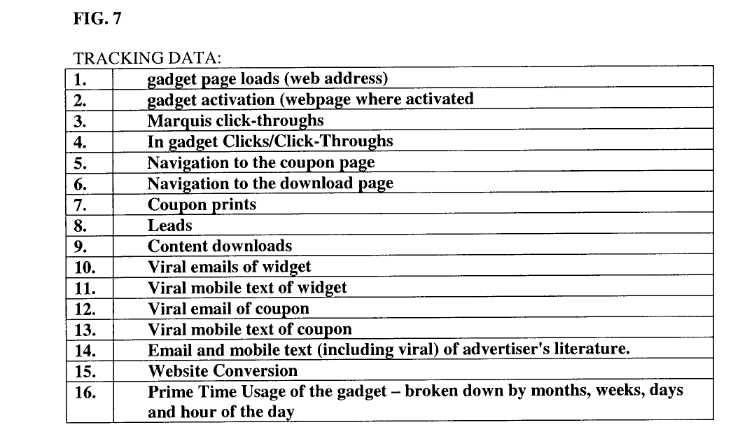

FIG. 7 illustrates exemplary data that can be tracked and measured by the gadget 104b and the gadget originator's processing system 200, according to one embodiment. This is a tracking and measuring of actions taken, within the gadget or on web pages linked to the gadget, or web pages linked to from the gadget (clicked to through the gadget), and a measurement of the “prime time” (or optimal ad display time) of a day, week and month of a given year during which an online ad is most effective to prompt gadget use and clicks of links provided in an online. The list in FIG. 7 is by no means complete, and it can be expanded to included other data deemed beneficial for tracking and measurement.

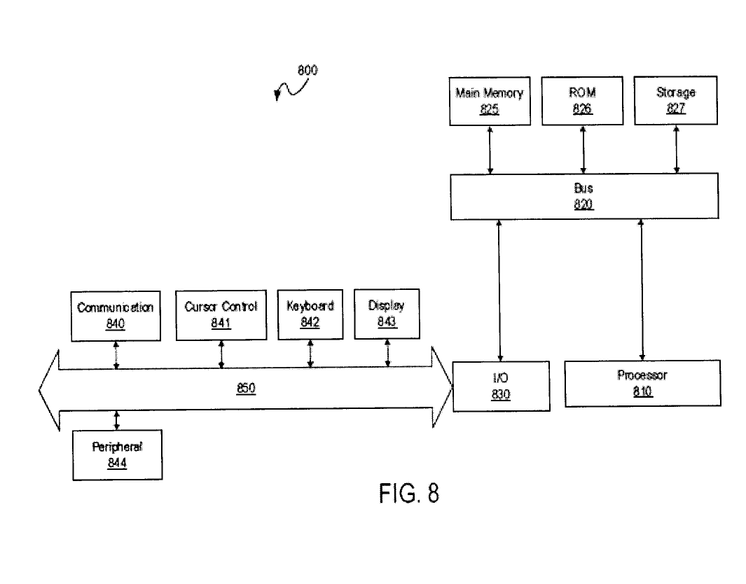

FIG. 8 illustrates an exemplary computer architecture for use with the present systems, according to one embodiment. Computer architecture 800 can be used to implement the computer systems described in various embodiments of the invention, including any of the modules described herein. One embodiment of the architecture 800 comprises a system bus 820 for communicating information, and a processor 810 coupled to the bus 820 for processing information. The architecture 800 further comprises a random access memory (RAM) or other dynamic storage device 825 (referred to herein as main memory), coupled to the bus 820 for storing information and instructions to be executed by the processor 810. Main memory 825 also may be used for storing temporary variables or other intermediate information during execution of instructions by the processor 810. The architecture 800 also may include a read only memory (ROM) and/or other static storage device 826 coupled to the bus 820 for storing static information and instructions used by the processor 810.

A data storage device 827 such as a flash memory, a magnetic disk or optical disc and its corresponding drive may also be coupled to the computer system architecture 800 for storing information and instructions. The architecture 800 can also be coupled to a second I/O bus 850 via an I/O interface 830. A plurality of I/O devices may be coupled to the I/O bus 850, including a display device 843, an input device (e.g., an alphanumeric input device 842 and/or a cursor control device 841).

The communication device 840 allows for access to other computers (servers or clients) via a network. The communication device 840 may comprise a modem, a network interface card, a wireless network interface or other well known interface device, such as those used for coupling to Ethernet, token ring, or other types of networks.

Although the present method and system have been described in connection with an interactive media system, one of ordinary skill would understand that the techniques described may be used in any situation where it is to render video or other media content to a user.

Methods and systems for enhanced advertising display and consumer purchase requests in an interactive environment have been disclosed. Although the present methods and systems have been described with respect to specific examples and subsystems, it will be apparent to those of ordinary skill in the art that it is not limited to these specific examples or subsystems but extends to other embodiments as well.

What is claimed is:

1. A computer-implemented method, comprising:
providing wrap code to a first entity connected to an electronic commerce network;
providing a gadget to the first entity;
receiving a request for content from a second entity connected to the electronic commerce network when the second entity activates the gadget; and
transmitting the content to the second entity.

2. The computer-implemented method of claim 1, wherein the content comprises product information for a product in an advertisement provided to the second entity by the first entity.

3. The computer-implemented method of claim 2, further comprising: integrating the gadget, wrap code, and advertisement at the first entity.

4. The computer-implemented method of claim 2, further comprising: integrating the gadget, wrap code, and advertisement at the second entity.

5. The computer-implemented method of claim 1, wherein the first entity is an advertising publisher and the second entity is a user client device, the user client device being one of a personal computer, a mobile device, and a set-top box.

6. A computer-implemented method, comprising:
integrating an electronic advertisement with a wrap code to generate an enhanced advertisement; and
transmitting the enhanced advertisement to a website;
wherein the wrap code is configured to retrieve a gadget upon activation of the wrap code by a client device displaying the enhanced advertisement.

7. The computer-implemented method of claim 6, further comprising providing the client device additional content, wherein the content comprises product information for a product in the enhanced advertisement.

8. The computer-implemented method of claim 7, wherein the client device is one of a personal computer, a mobile device, and a set-top box.

9. A computer-implemented method, comprising:
receiving an enhanced electronic advertisement having a wrap code;
transmitting the enhanced advertisement to a client device; and
retrieving a gadget upon activation of the wrap code by the client device displaying the enhanced advertisement.

10. The computer-implemented method of claim 9, further comprising providing the client device additional content, wherein the content comprises product information for a product in the enhanced advertisement.

11. The computer-implemented method of claim 10, wherein the client device is one of a personal computer, a mobile device, and a set-top box.

12. A computer system, comprising:
a processor; and
memory coupled to the processor, the memory storing instructions;
wherein the instructions when executed by the processor cause the processor to:
provide wrap code to a first entity connected to an electronic commerce network;
provide a gadget to the first entity;
receive a request for content from a second entity connected to the electronic commerce network when the second entity activates the gadget; and
transmit the content to the second entity.

13. The computer system of claim 12, wherein the content comprises product information for a product in an advertisement provided to the second entity by the first entity.

14. The computer system of claim 13, wherein the instructions cause the processor to: integrate the gadget, wrap code, and advertisement at the first entity.

15. The computer system of claim 13, wherein the instructions cause the processor to: integrate the gadget, wrap code, and advertisement at the second entity.

16. The computer system of claim 12, wherein the first entity is an advertising publisher and the second entity is a user client device, the user client device being one of a personal computer, a mobile device, and a set-top box.

17. A computer system, comprising:
a processor; and
memory coupled to the processor, the memory storing instructions;
wherein the instructions when executed by the processor cause the processor to:
integrate an electronic advertisement with a wrap code to generate an enhanced advertisement; and
transmit the enhanced advertisement to a website;
wherein the wrap code is configured to retrieve a gadget upon activation of the wrap code by a client device displaying the enhanced advertisement.

18. The computer system of claim 17, wherein the instructions cause the processor to: provide the client device additional content, wherein the content comprises product information for a product in the enhanced advertisement.

19. The computer system of claim 18, wherein the client device is one of a personal computer, a mobile device, and a set-top box.

20. A computer system, comprising:
a processor; and
memory coupled to the processor, the memory storing instructions;
wherein the instructions when executed by the processor cause the processor to:
receive an enhanced electronic advertisement having a wrap code;
transmit the enhanced advertisement to a client device; and
retrieve a gadget upon activation of the wrap code by the client device displaying the enhanced advertisement.

21. The computer system of claim 20, wherein the instructions cause the processor to: provide the client device additional content, wherein the content comprises product information for a product in the enhanced advertisement.

22. The computer system of claim 21, wherein the client device is one of a personal computer, a mobile device, and a set-top box.
